(19) United States
(12) Patent Application Publication
(10) Pub. No.: US 2008/0267133 A1
(43) Pub. Date: Oct. 30, 2008

(54) MIMO WIRELESS COMMUNICATION SYSTEM, MIMO WIRELESS COMMUNICATION APPARATUSES, AND WIRELESS COMMUNICATION METHOD

(76) Inventors: Masaaki Shida, Hachioji (JP); Takashi Yano, Tokorozawa (JP); Shigenori Hayase, Kodaira (JP); Keisuke Yamamoto, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/032,046

(22) Filed: Feb. 15, 2008

(30) Foreign Application Priority Data
Apr. 27, 2007 (JP) 2007-119447

(51) Int. Cl. H04Q 7/20

(52) U.S. Cl. 370/334

(57) ABSTRACT

When a plurality of user stations (STAs) simultaneously communicate with an access point (AP) through an SDMA (Space Division Multiple Access) channel in a MIMO wireless communication system, these STAs control their respective transmission signals such that each signal is received by only a different one of the plurality of antennas at the AP. (It should be noted that the number of these STAs is equal to or smaller than the number of antennas at the AP.) This eliminates the need for the AP to perform MIMO processing, thereby allowing the AP to properly receive and demodulate the signals even if they differ in carrier frequency and transmission timing, which would otherwise result in communication degradation or failure.

### CLAIM OF PRIORITY

The present application claims priority from Japanese application JP 2007-119447 filed on Apr. 27, 2007, the content of which is hereby incorporated by reference into this application.

### FIELD OF THE INVENTION

The present invention relates to a MIMO wireless communication system, and more particularly to a MIMO wireless communication system in which access points and user stations communicate with each other through an SDMA channel in such a manner as to avoid communication degradation and failure due to MIMO processing at the access points.

Prior art includes the following references:

An SDMA (Space Division Multiple Access) technique is disclosed in T. Ohgane, “A study on a channel allocation scheme with an adaptive array in SDMA,” IEEE 47^{th} VTC, Vol. 2, 1997, p. 725-729.

An SDM (Space Division Multiplexing) technique is disclosed in G. J. Foschini, “Layered space-time architecture for wireless communication in a fading environment when using multi-element antennas,” Bell Labs Tech. J, Autumn 1996, p. 41-59.

A MIMO (Multiple-Input Multiple-Output)-SDMA technique is disclosed in Andre Bourdoux, Nadia Khaled, “Joint Tx-Rx Optimization for MIMO-SDMA Based on a Null-space Constraint,” IEEE2002, p. 171-172.

Japanese Laid-Open Patent Publication No. 2005-102136 discloses an MIMO-SDMA communication system using an antenna array in which the signal transmitted from each antenna is weighted to provide an SDM communication channel.

### BACKGROUND OF THE INVENTION

Considerable attention has been given to the types of antennas and signal processing techniques that can dramatically increase the spectral efficiency and data rate of wireless communications. One of such techniques is referred to as the “adaptive array antenna,” or “AAA technique,” in which the amplitude and phase of signals transmitted/received through the multiple antennas are adjusted according to the weighting coefficients assigned to them. This increases the signal-to-noise ratio and the channel capacity of the system. There is a technique called “MIMO” which utilizes an AAA technique to increase data rate. MIMO allows wireless communication systems to establish between the transmitter and receiver as many channels as there are antennas in order to increase the channel capacity.

The following techniques will now be described in more detail: (1) SDMA (Space Division Multiple Access), which is used to transmit signals to a plurality of different stations; and (2) SDM (Space Division Multiplexing), which is used to transmit signals to a single station through several spatial channels.

SDMA allows, for example, a base station (or access point) to transmit or receive different data steams to or from a plurality of stations or user terminals through multiple antennas in the same frequency band simultaneously. This is accomplished by adjusting the amplitude and phase of the signals to be transmitted or received according to the weighting coefficients assigned to them, such that these signals are spatially orthogonal to each other. On the other hand, SDM allows, for example, a base station to transmit or receive different data streams to or from a single station or user terminal through multiple antennas in the same frequency band simultaneously. This is also accomplished by adjusting the amplitude and phase of the signals to be transmitted or received according to the weighting coefficients assigned to them, such that these signals are spatially orthogonal to each other.

Further, MIMO-SDMA, which is a combination of SDMA and SDM, allows, for example, a base station to transmit or receive data streams to or from a plurality of stations through an SDMA channel while transmitting or receiving data streams to or from a single station through an SDM channel.

Further, in wireless LAN systems using the above techniques, an access point (AP) can receive ACK (Acknowledgement) packets from a plurality of stations simultaneously by a known method after transmitting different data streams to these stations.

Incidentally, in conventional MIMO wireless communication systems, when SDMA signals from a plurality of stations are (simultaneously) uplinked to an access point, the access point must perform MIMO processing on these signals so as to separate the signal from each station from those from the other stations (or demultiplex the signals). It has happened, however, that the access point cannot separate these signals or cannot fully separate them from each other resulting in degraded output signals, since the signal from each station is bound to differ in carrier frequency and transmission timing from the signals from the other stations due to inherent errors.

### SUMMARY OF THE INVENTION

In order to solve the above problems, the present invention provides a MIMO wireless communication system comprising: at least one first MIMO (Multiple Input Multiple Output) wireless communication apparatus having a plurality of antennas for transmitting a signal; and a second MIMO wireless communication apparatus having a plurality of antennas for receiving the signal transmitted from the at least one first MIMO wireless communication apparatus; wherein the at least one first MIMO wireless communication apparatus controls the signal transmitted from its plurality of antennas based on channel state information (CSI) for a communication channel between the at least one first MIMO wireless communication apparatus and the second MIMO wireless communication apparatus such that the signal strength of the signal as received by at least one of the plurality of antennas of the second MIMO wireless communication apparatus does not exceed zero or a predetermined level.

Further, it may be arranged that at least one of the plurality of antennas of the second MIMO wireless communication apparatus only receives signals transmitted from one of the at least one first MIMO wireless communication apparatus, thereby eliminating the need for the second MIMO wireless communication apparatus to perform MIMO processing on these signals to separate or demultiplex them.

The MIMO wireless communication system may be further configured such that: one or more of the at least one first MIMO wireless communication apparatus simultaneously transmit signals to the second MIMO wireless communication apparatus; and the number of the one or more first MIMO wireless communication apparatuses is smaller than the number of the plurality of antennas of the second MIMO wireless communication apparatus and also smaller than the smallest number of antennas of any of the at least one first MIMO wireless communication apparatus. This allows the at least one first MIMO wireless communication apparatus to control the signal transmitted from its plurality of antennas such that the signal strength of the signal as received by at least one of the plurality of antennas of the second MIMO wireless communication apparatus does not exceed zero or a predetermined level.

The at least one first MIMO wireless communication apparatus may generate channel state information by channel estimation based on a signal transmitted from the second MIMO wireless communication apparatus.

Alternatively, it may be arranged that: the second MIMO wireless communication apparatus generates channel state information by channel estimation based on the signal transmitted from the at least one first MIMO wireless communication apparatus, and transmits a signal containing the channel state information to the at least one first MIMO wireless communication apparatus; and the at least one first MIMO wireless communication apparatus demodulates the signal transmitted from the second MIMO wireless communication apparatus and obtains the channel state information contained in the signal.

Further, in order to accommodate MIMO wireless communication apparatuses having various numbers of antennas, the MIMO wireless communication system may be further configured such that in response to an inquiry from the second MIMO wireless communication apparatus, the at least one first MIMO wireless communication apparatus notifies the second MIMO wireless communication apparatus of the number of antennas of the at least one first MIMO wireless communication apparatus.

The second MIMO wireless communication apparatus may begin data communication with the at least one first MIMO wireless communication apparatus after obtaining information about the number of antennas of the at least one first MIMO wireless communication apparatus.

Thus, the present invention provides a MIMO wireless communication system in which an access point(s) and a plurality of user stations communicate with each other through an SDMA channel in such a manner as to avoid communication degradation and failure due to MIMO processing at the access point.

### BRIEF DESCRIPTION OF THE DRAWINGS

FIG. 1 is a diagram illustrating the concept of a MIMO wireless communication system according to the present invention.

FIG. 2 is a diagram showing the overall configuration of a MIMO wireless communication system according to a first embodiment of the present invention.

FIG. 3 is a block diagram of an access point.

FIG. 4 is a block diagram of a station (or user terminal).

FIG. 5 is a block diagram showing the detailed configuration of a wireless communication processing unit 9.

FIG. 6 is a diagram showing the detailed configuration of a MIMO receive processing unit.

FIG. 7 is a diagram showing a packet format.

FIG. 8 is a timing chart of a communication procedure between an access point and stations according to the first embodiment of the present invention, showing steps from the acquisition of channel state information to the transmission of data packets.

FIG. 9 is a timing chart of a communication procedure between an access point and stations according to a second embodiment of the present invention, showing steps from the acquisition of channel state information to the transmission of data packets.

### DETAILED DESCRIPTION OF THE PREFERRED EMBODIMENTS

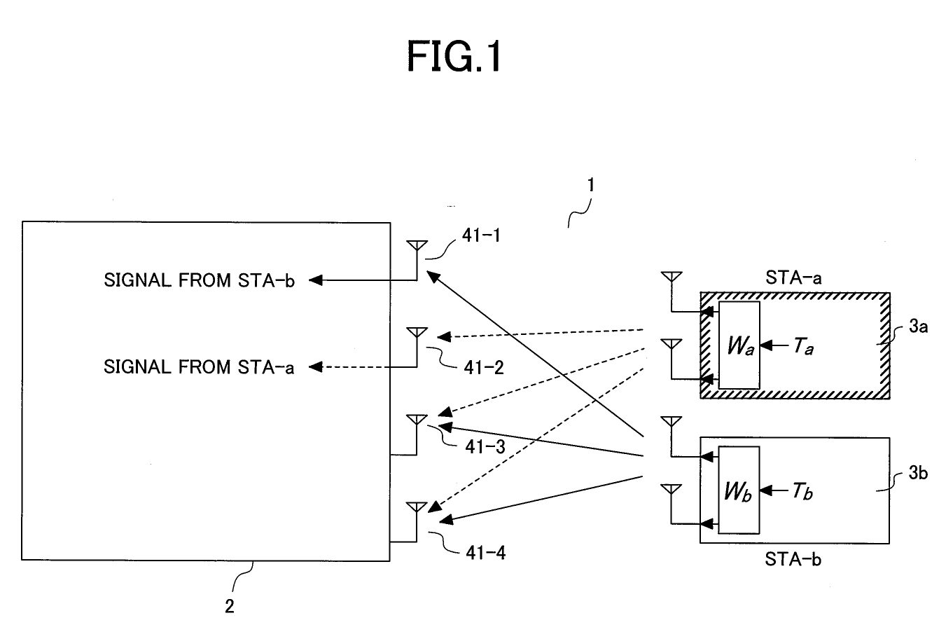

Preferred embodiments of the present invention will be described with reference to FIGS. 1 to 9.

### First Embodiment

A first embodiment of the present invention will now be described with reference to FIGS. 1 to 8.

First of all, a MIMO wireless communication system of the first embodiment will be described with reference to FIGS. 1 to 4.

FIG. 1 is a diagram illustrating the concept of a MIMO wireless communication system according to the present invention.

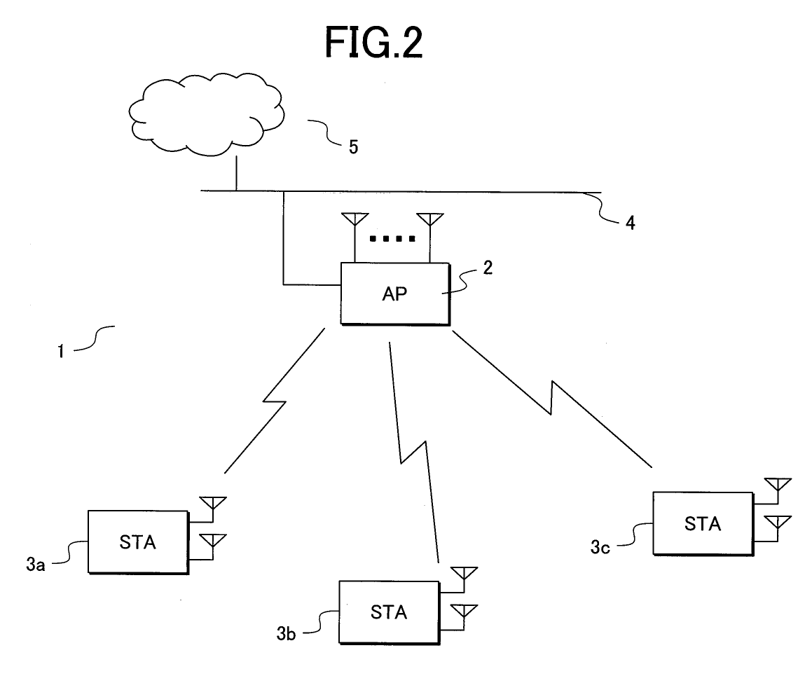

FIG. 2 is a diagram showing the overall configuration of the MIMO wireless communication system according to the present embodiment.

The MIMO wireless communication system of the present embodiment includes at least one access point (AP) 2 and a plurality of stations (STAs) 3, as shown in FIG. 2. (It should be noted that the following description assumes that there is only one AP 2.)

The AP 2 has a plurality of antennas, and at least two of the STAs 3 have a plurality of antennas. The AP 2 communicates with the STAs 3 via a MIMO channel. The AP 2 is connected to a wired network 4 which in turn is connected to, e.g., the Internet 5.

The present embodiment will be described in connection with an illustrative MIMO wireless communication system which includes one AP 2 and two STAs 3a and 3b, as shown in FIG. 1. In the MIMO wireless communication system shown in FIG. 1, the AP 2 has four antennas, and the STAs 3a and 3b each have two antennas.

The STA 3a controls its transmission signal so as to steer a null in the radiation pattern toward an antenna 41-1 at the AP 2. Further, the STA 3b controls its transmission signal so as to steer a null in the radiation pattern toward an antenna 41-2 at the AP 2. More specifically, the STA 3a obtains its uplink (i.e., STA-to-AP) channel state information (in a manner described later), and adjusts the amplitude and phase of its transmission signal based on this information such that the power level of the signal as received by the antenna 41-1 at the AP 2 is substantially zero. (In other words, the multipath copies of the signal cancel each other at this antenna.) Likewise, the STA 3b obtains its uplink channel state information and adjusts the amplitude and phase of its transmission signal based on this information such that the power level of the signal as received by the antenna 41-2 at the AP 2 is substantially zero.

That is, the antenna 41-1 at the AP 2 only receives the signal from the STA 3b and does not receive the signal from the STA 3a. On the other hand, the antenna 41-2 at the AP 2 only receives the signal from the STA 3a and does not receive the signal from the STA 3b.

As a result, the signals from the STAs 3b and 3a are received by the antennas 41-1 and 41-2, respectively, independently of each other, thereby eliminating the need for MIMO processing. This means that these signals can be demodulated even if they differ in carrier frequency and transmission timing.

Although the present embodiment has been described in connection with an illustrative MIMO wireless communication system in which one AP communicates with two STAs, the present embodiment may be applied to other configurations. For example, in the case of a MIMO wireless communication system including one AP and three STAs, the system may be controlled such that each two of these three STAs steer a null in their radiation patterns toward a different one of the antennas at the AP. (This ensures that each antenna of the AP can only receive the signal from a selected one of the STAs.) Thus, a MIMO wireless communication including one AP and a plurality of STAs may be controlled based on the number of antennas at the AP, the number of antennas at each STA, and the number of STAs with which the AP communicates at one time, as described in detail later.

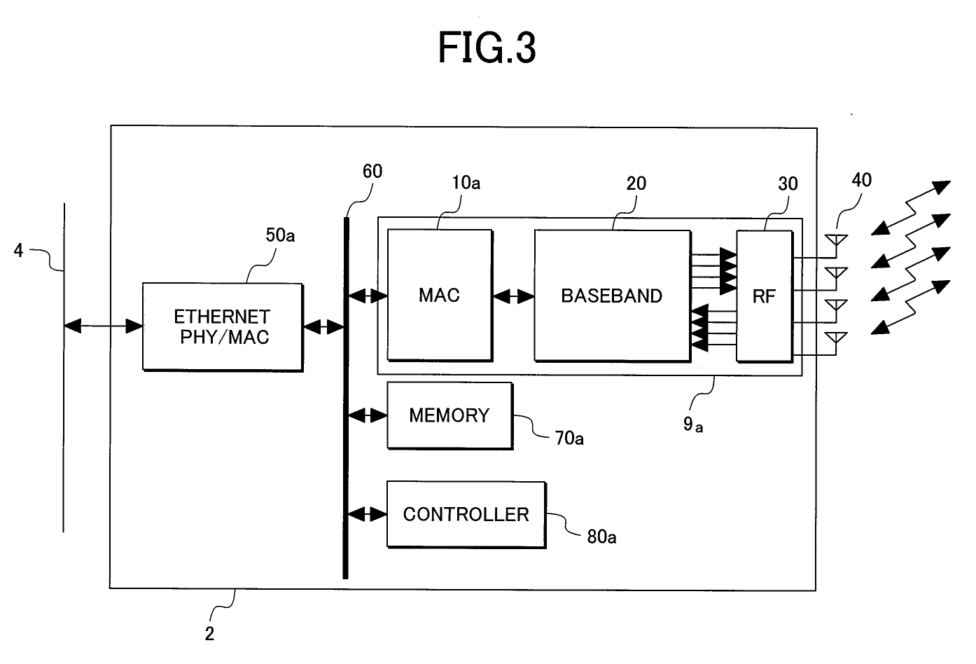

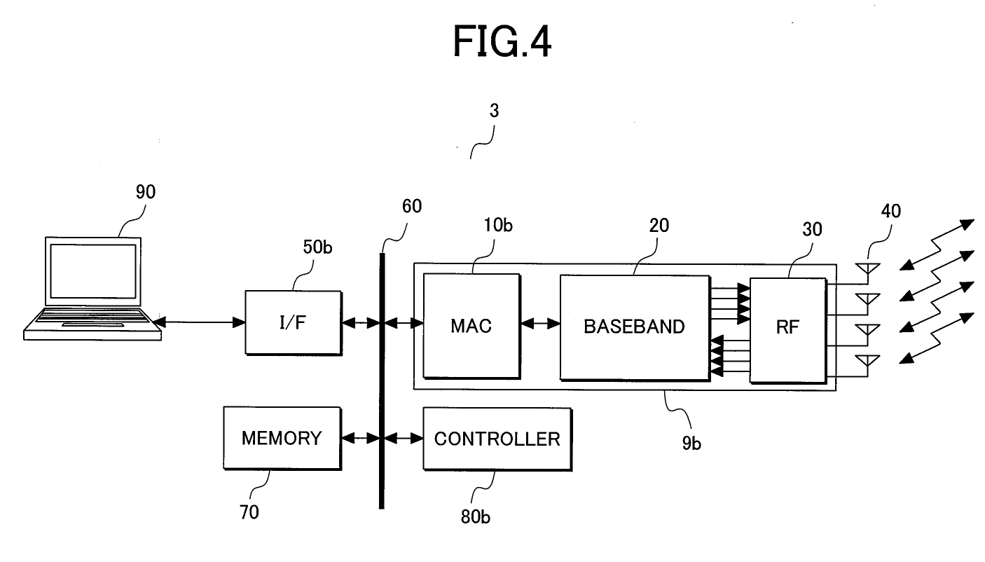

The configurations of the AP 2 and the STAs 3 in the MIMO wireless communication system of the present embodiment will now be described with reference to FIGS. 3 and 4.

FIG. 3 is a block diagram of the access point (AP) 2.

FIG. 4 is a block diagram of each station (STA) 3.

The AP 2 includes a wireless communication processing unit 9a, an Ethernet® physical layer/MAC layer interface 50a, a bus 60, memory 70a, and a controller 80a, as shown in FIG. 3.

In order for the AP 2 to wirelessly communicate with the STAs 3, the wireless communication processing unit 9a modulates data and sends it to the STAs 3, as well as demodulating signals received from the STAs 3 into data.

The Ethernet physical layer/MAC layer interface 50a provides a connection between a wired network 4 and the AP 2. When the STAs 3 transmit data to an external device connected to the wired network 4, the data is temporarily held in the memory 70a and then output to the Ethernet physical layer/MAC layer interface 50a through the bus 60 in response to an instruction from the controller 80a. Likewise when an external device connected to the wired network 4 transmits data to the STAs 3, the data received by the AP 2 is temporarily held in the memory 70a and then output to the MAC unit 10a in the wireless communication processing unit 9a through the bus 60 in response to an instruction from the controller 80a.

The wireless communication processing unit 9a includes the media access control (MAC) unit 10a, a baseband (BB) unit 20, a radio frequency (RF) unit 30, and an antenna unit 40.

The MAC unit 10a controls channel access such that the AP 2 can simultaneously transmit or receive data to or from several STAs 3 through an SDMA channel. (The data transmission and reception procedures are described in detail later.) The baseband unit 20, under the control of the MAC unit 10a, encodes, modulates, and performs MIMO processing on data to be transmitted to produce a baseband transmission signal which is fed into the RF unit 30. The baseband unit 20 also performs MIMO processing, demodulation, and error correction on the baseband signal received through the RF unit 30 and outputs the resultant signal to the MAC unit 10a as received data.

The RF unit 30 up-converts the baseband transmission signal received from the baseband unit 20 to a carrier frequency and outputs it to the antenna unit 40. The RF unit 30 also has a function to down-convert the radio frequency signal received through the antenna unit 40 to a baseband signal and outputs it to the baseband unit 20.

The antenna unit 40 radiates the radio frequency signal received from the RF unit 30 into space. The antenna unit 40 also has a function to receive signals propagated through space and pass them to the RF unit 30.

On the other hand, each STA 3 includes a wireless communication processing unit 9b, an interface 50b, a bus 60, memory 70, a controller 80b, and a computer 90, as shown in FIG. 4. The wireless communication processing unit 9b includes a MAC unit 10b, a BB unit 20, an RF unit 30, and an antenna unit 40. The baseband unit 20, the RF unit 30, the antenna unit 40, the bus 60, and the memory 70 function in the same manner as described above in connection with the AP 2.

The MAC unit 10b receives and outputs data in response to a control packet from the AP 2. The received data is temporarily held in the memory 70 and then output to the computer 90 through the I/F 50b under the control of the controller 80b.

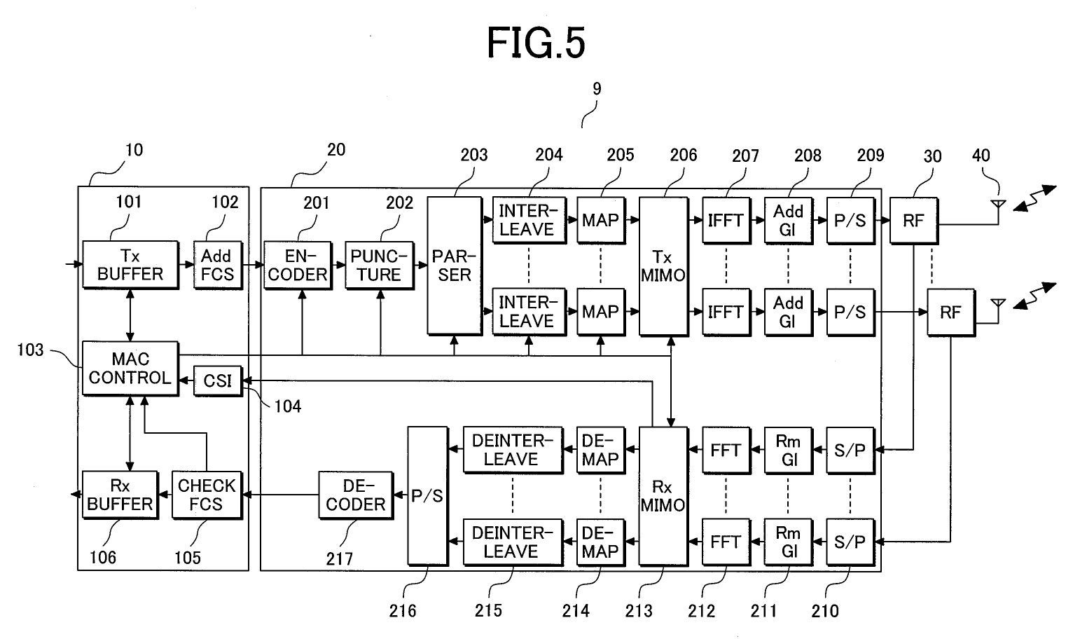

The communication operations of the AP 2 and the STAs 3 will be described with reference to FIGS. 5 to 8.

FIG. 5 is a block diagram showing the detailed configuration of a wireless communication processing unit 9 (corresponding to the wireless communication processing units 9a and 9b shown in FIGS. 3 and 4).

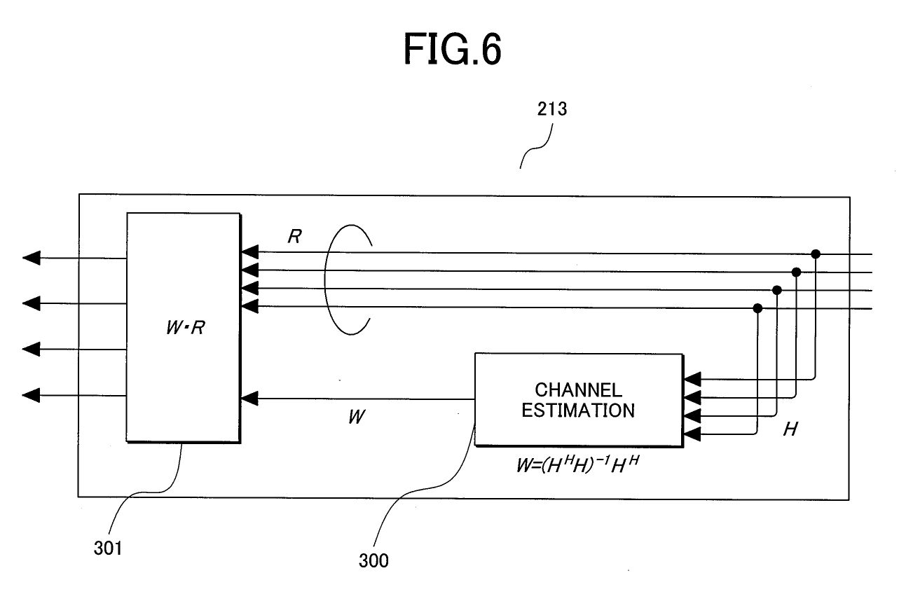

FIG. 6 is a diagram showing the detailed configuration of the MIMO receive processing unit.

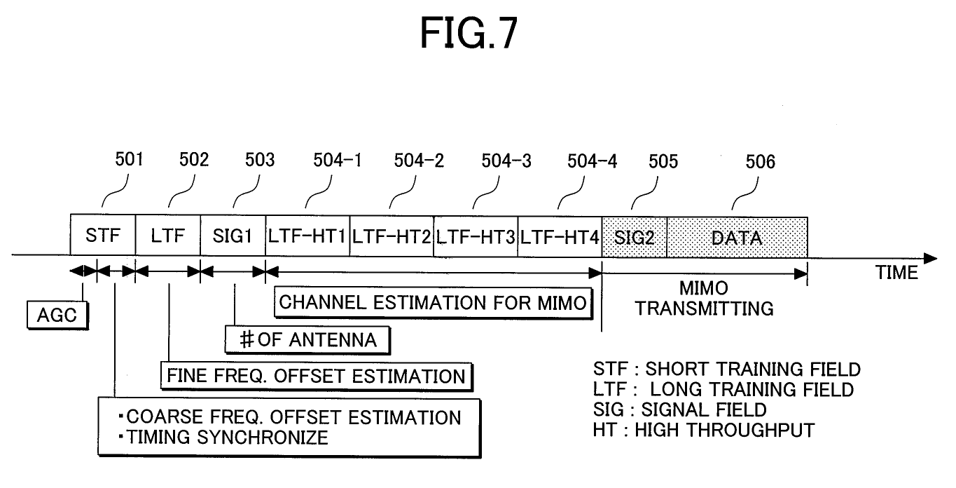

FIG. 7 is a diagram showing the packet format.

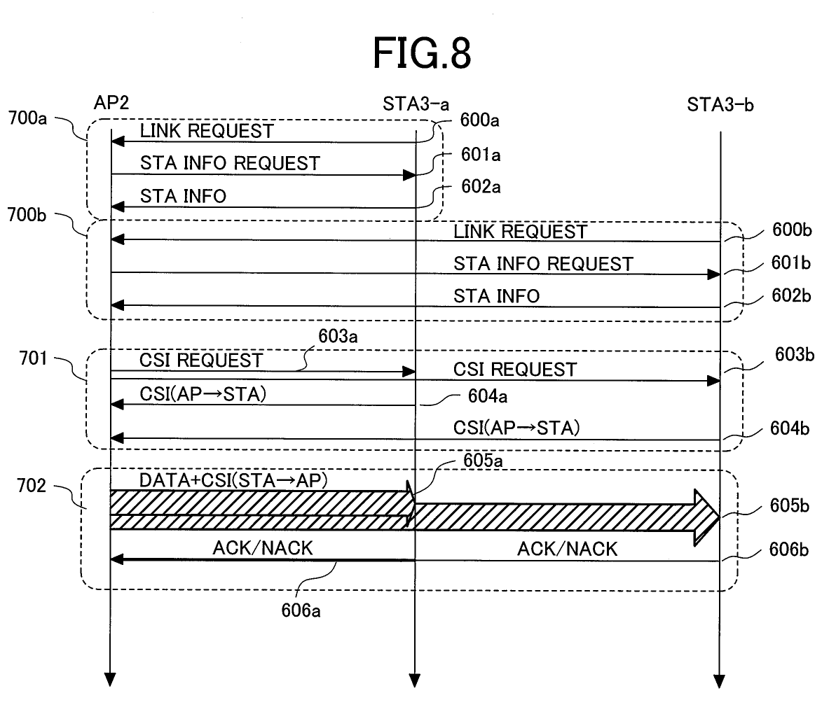

FIG. 8 is a timing chart of a communication procedure between the access point (AP) and the stations (STAs) according to the present embodiment, showing steps from the acquisition of channel state information to the transmission of data packets.

Let it be assumed, for example, that a plurality of STAs 3 desire to receive data from the AP 2 simultaneously (or the AP 2 desires to transmit data to a plurality of STAs 3 simultaneously). In such a case, according to the present embodiment, these STAs first transmit their channel state information to the AP 2. Channel state information is a mathematical value which represents the signal channel from transmit antennas to receive antennas and may be expressed by using the gain and the amount of phase shift of the signals transmitted through the channel. Let it be assumed, for example, that M transmit antennas at a transmitter transmit signals through a channel to N receive antennas at a receiver. The signals (or signal strengths of the signals) received by the receive antennas are expressed by Eq. 1 below.

$$( \begin{matrix}{r}_{1} \\ {r}_{2} \\ ⋮ \\ {r}_{N}\end{matrix} ) = H ( \begin{matrix}{s}_{1} \\ {s}_{2} \\ ⋮ \\ {s}_{M}\end{matrix} ) = ( \begin{matrix}{h}_{11} & {h}_{12} & … & {h}_{1 M} \\ {h}_{21} & {h}_{22} & & {h}_{2 M} \\ ⋮ & & ⋰ & ⋮ \\ {h}_{N 1} & {h}_{N 2} & … & {h}_{NM}\end{matrix} ) ( \begin{matrix}{s}_{1} \\ {s}_{2} \\ ⋮ \\ {s}_{M}\end{matrix} ) \qquad ( Eq . 1 )$$

where s₁, s₂, . . . , s_{M} are the transmitted signals, r₁, r₂, . . . , r_{N} are the received signals, and H is the channel state information.

Each STA 3 simultaneously transmits both data and channel state information to the AP 2. Further, when each STA 3 returns an ACK packet to the AP 2 (after receiving data from the AP2), it performs signal processing on the packet based on the channel state information, as described below.

FIG. 5 is a block diagram showing the detailed configuration of a wireless communication processing unit 9 for MIMO-OFDM (Orthogonal Frequency Division Multiplexing). This wireless communication processing unit 9 corresponds to both the wireless communication processing units 9a and 9b shown in FIGS. 3 and 4, respectively. The following first describes the operations common to the AP 2 and the STAs 3 and then their specific operations.

The wireless communication processing unit 9 includes a MAC unit 10, a BB unit 20, an RF unit 30, and an antenna unit 40. The primary function of the MAC unit 10 is to control the exchange of packets with other wireless communication apparatus. It includes a transmit buffer 101, an FCS (Frame Check Sequence) adder 102, a MAC controller 103, a channel state information storage unit 104, an FCS checker 105, and a receive buffer 106. The MAC controller 103 controls the transmission timing and also controls the BB unit during transmission to control the modulation level, the error correction coding rate, and the amplitude and phase of the signals transmitted from the multiple antennas.

The BB unit 20 modulates and transmits data and demodulates the signal received through the RF unit 30 under the control of the MAC unit 10. The BB unit 20 includes an error correction encoder 201, a puncturing unit 202, a parser 203, an interleaver 204, a modulator 205, a MIMO transmit processing unit 206, an inverse FFT unit 207, a guard interval adder 208, a parallel-to-serial converter 209, a serial-to-parallel converter 210, a guard interval remover 211, an FFT unit 212, a MIMO receive processing unit 213, a demodulator 214, a deinterleaver 215, a parallel-to-serial converter 216, and an error correction decoder 217.

Transmission operation is initiated under the control of the MAC controller 103 when data to be transmitted is input into the transmit buffer 101. The data is then output from the transmit buffer 101 to the FCS adder 102. The FCS adder 102 adds an FCS, which uses a cyclic code, to the end of the data stream. The data with the FCS is then subjected to error correction encoding in the error correction encoder 201. Examples of error correction encoding include convolutional encoding and turbo encoding. The encoded signal (or data stream) is punctured in a prescribed manner by the puncturing unit 202 under the control of the MAC controller 103. The parser 203 then divides the punctured data into a plurality of data streams, which are then each interleaved by the interleaver 204. Each interleaved data stream is modulated by the modulator 205 under the control of the MAC controller 103. Examples of modulation schemes include BPSK, QPSK, 16 QAM, and 64 QAM. The modulated signals, or data steams, are grouped for each sub-carrier by the MIMO transmit processing unit 206 in response to an instruction from the MAC controller 103. These signals are subjected to OFDM modulation. Specifically, they are IFFT processed by the inverse FFT unit 207, and then a guard interval is added to each symbol in the signals by the guard interval adder 208. The parallel-to-serial converter 209 serializes the resultant signals and outputs the serialized signals to the RF unit 30 (see FIG. 5).

Upon receiving the serialized signals (to be transmitted) from the BB unit 20, the RF unit 30 up-converts them to a carrier frequency and outputs the up-converted signals to the antenna unit 40. (It should be noted that the RF unit 30 also has a function to receive an RF signal from the antenna unit 40, down-convert it, and output the down-converted signal to the BB unit 20.)

The antenna unit 40 has a function to efficiently radiate the radio frequency signal (to be transmitted) received from the RF unit 30 into space, as well as a function to efficiently receive signals propagated through space and output them to the RF unit 30. The antenna unit 40 includes a plurality of antennas to provide MIMO communications.

The reception operation of the wireless communication processing unit 9 proceeds as follows. Each signal received through the RF unit 30 is input to the serial-to-parallel converter 210 which parallelizes it for output to the guard interval remover 211. The guard interval remover 211 then removes the guard intervals from the parallelized signal which is then FFT processed by the FFT unit 212. Upon receiving all the FFT processed signals, the MIMO receive processing unit 213 estimates the channel from them (in a manner described later) and thereby generates channel state information. The MIMO receive processing unit 213 then demodulates (or demultiplexes) the signals based on the generated channel state information using a known algorithm such as the ZF (Zero Forcing) or MMSE (Minimum Mean Square Error) algorithm. The output of the MIMO receive processing unit 213 is demodulated by the demodulator 214 and then deinterleaved by the deinterleaver 215. The deinterleaved signals (or streams) are serialized and put together by the parallel-to-serial converter 216. The resultant single data stream is error corrected by the error correction decoder 217 and then output to the MAC unit 10. The FCS checker 105 in the MAC unit 10 checks each packet in the data stream for data errors while at the same time storing the data stream in the receive buffer 106.

If it is determined that the data contains no errors (i.e., the data reception is successful), the MAC controller 103 generates an ACK packet and transmits it in the manner described above. Further, at the same time, the MAC controller 103 causes the data stored in the receive buffer 106 to be output to a higher-level layer.

If, on the other hand, the data is erroneous, then the MAC controller 103 generates a NACK packet and transmits it in the manner described above. Further, at the same time, the MAC controller 103 causes the data stored in the receive buffer 106 to be discarded.

FIG. 6 shows the detailed configuration of the MIMO receive processing unit 213. (FIG. 6 assumes that there are four antennas.) The signal received through each antenna is input to an inverse matrix calculation unit 300 and a multiplication unit 301. Receiving these signals, the inverse matrix calculation unit 300 calculates the weight vector W for them by Eq. 2 below.

W=(H^{H}H)⁻¹H^{H} (Eq. 2)

where H is the CSI matrix or vector.

The multiplication unit 301 multiplies the received signal vector by the weight vector W to produce the demodulated (or demultiplexed) signals.

The signals input to the inverse matrix calculation unit 300 will now be described with reference to FIG. 7. FIG. 7 shows the packet structure. The wireless communication processing unit 9 demodulates each received data stream based on data in each packet. Referring to FIG. 7, the STF field 501 is used to perform AGC (Automatic Gain Control), frequency offset correction between the transmitter and receivers, and symbol timing synchronization. The LTF field 502 is used to accurately correct the frequency offset. The SIG1 field 503 indicates the number of antennas used to transmit this packet. The LTF-HT1, LTF-HT2, LTF-HT3, and LTF-HT4 fields each contain a channel estimate for a respective one of the antennas. (That is, 4 transmit antennas were used to send this packet.) It should be noted that since each antenna transmits a signal on a different subcarrier, the receive antennas can receive all the transmitted channel state information (or channel estimates). The weight vector W is obtained in the manner described above using the channel state information (denoted by H). The received signal contained in the SIG2 field 505 and the data contained in the Data field 506 are multiplied by the obtained weight vector W.

Each STA 3 steers a null in the radiation pattern toward a different antenna at the AP 2 based on uplink (i.e., STA-to-AP) channel state information received from the AP 2. This procedure will be described in detail with reference to FIG. 8.

First, the AP 2 obtains downlink (i.e., AP-to-STA) channel state information from each STA 3. The AP 2 then transmits data to the STAs 3 through an SDMA channel. This data includes uplink channel state information. Receiving this data including the uplink channel state information, each STA 3 transmits an ACK or NACK packet to the AP 2 in such a way as to steer a null in the radiation pattern toward an antenna at the AP based on the received uplink channel state information. (That is, the multipath copies of the transmitted signal cancel each other at this particular antenna.) In FIG. 8, the AP 2 performs first and second steps 700 and 701 (described later) before transmitting data packets to the STAs 3 at a third step 702. Specifically, the STAs 3 (i.e., STA 3-a and STA 3-b) begin to establish communication with the AP 2 by transmitting link request packets 600a and 600b, respectively. Upon receiving these link request packets, the AP 2 transmits STA information request packets 601a and 601b to the STA 3-a and STA 3-b, respectively. In response the STAs 3-a and 3-b transmit information packets 602a and 602b, respectively, to the AP 2. These information packets contain information about the number of antennas at their respective STAs as well as information as to whether or not the STAs have null steering capability. It should be noted that if the AP 2 already has information about the number of antennas at each STA, the AP 2 need not transmit the STA information request packets 601a and 601b and hence the STAs need not return the information packets 602a and 602b.

Thus, in this example, there are two STAs 3 (i.e., STA 3-a and 3-b), and they simultaneously send their respective link request packets to the AP 2. After receiving the information packets 602a and 602b (at step 700), at step 701 the AP 2 obtains downlink (i.e., AP-to-STA) channel state information from the STA or STAs to which it is to transmit data. Specifically, the AP 2 first transmits channel state information request packets 603a and 603b to the STA 3-a and STA 3-b, respectively. When each STA (3-a, 3-b) receives a respective channel state information request packet, the MIMO receive processing unit 213 in its wireless communication processing unit 9b generates downlink channel state information by channel estimation and stores it in the channel state information storage unit 104. The STAs 3-a and 3-b then transmit channel state information packets 604a and 604b, respectively, to the AP 2. The data portions of these packets contain the generated downlink channel state information.

When the AP 2 receives the channel state information packets 604a and 604b from the STAs 3-a and 3-b, the AP 2 generates uplink (i.e., STA-to-AP) channel state information for both the STAs 3-a and 3-b by channel estimation and stores it in its channel state information storage unit 104, as in the case of the uplink channel state information in the STAs. The AP 2 then transmits data/channel state information packets 605a and 605b to the STAs 3-a and 3-b, respectively, through the SDMA channel based on the downlink channel state information supplied from each STA (step 702). These data/channel state information packets contain data and the generated uplink channel state information.

Each STA (3-a, 3-b) then receives a respective data/channel state information packet and outputs the data contained in the packet to a higher-level layer. The STAs 3-a and 3-b also transmit response frames 606a and 606b, respectively. At that time, each STA controls its transmission signal based on the received uplink channel state information in such a way as to steer a null in the radiation pattern toward a particular antenna at the AP 2.

There will now be described in detail how each STA steers a null in the radiation pattern toward a specific antenna at the AP 2 based on its received uplink channel state information.

Let it be assumed, for example, that in the MIMO wireless communication system, STAs 3a and 3b each have two antennas, as in FIG. 1. The following equations represent the uplink channel state information (Hₐ) for the STA 3a, the uplink channel state information (H_{b}) for the STA 3b, the signals (Tₐ and T_{b}) transmitted from the STAs 3a and 3b, respectively, and the weight vectors (Wₐ and W_{b}) for the STAs 3a and 3b, respectively.

$${H}_{a} = ( \begin{matrix}{h}_{a 11} & {h}_{a 12} \\ {h}_{a 21} & {h}_{a 22} \\ {h}_{a 31} & {h}_{a 32} \\ {h}_{a 41} & {h}_{a 42}\end{matrix} ) \\ {H}_{b} = ( \begin{matrix}{h}_{b 11} & {h}_{b 12} \\ {h}_{b 21} & {h}_{b 22} \\ {h}_{b 31} & {h}_{b 32} \\ {h}_{b 41} & {h}_{b 42}\end{matrix} ) \\ {T}_{a} = ( \begin{matrix}{t}_{a 1} \\ {t}_{a 2}\end{matrix} ) \\ {T}_{b} = ( \begin{matrix}{t}_{b 1} \\ {t}_{b 2}\end{matrix} ) \\ {W}_{a} = ( \begin{matrix}{w}_{a 11} & {w}_{a 12} \\ {w}_{a 21} & {w}_{a 22}\end{matrix} ) \\ {W}_{b} = ( \begin{matrix}{w}_{b 11} & {w}_{b 12} \\ {w}_{b 21} & {w}_{b 22}\end{matrix} ) \qquad ( Eq . 3 )$$

It should be noted that the weight vector Wₐ is determined such that the signal Tₐ transmitted from the STA 3a cannot be received by the antenna 41-1 at the AP 2, meaning that the signal strength (or level) of the signal from the STA 3a is zero at this antenna. That is, the following equation holds.

$${H}_{a} {W}_{a} {T}_{a} = ( \begin{matrix}{r}_{a 1} \\ {r}_{a 2} \\ {r}_{a 3} \\ {r}_{a 4}\end{matrix} ) = ( \begin{matrix}0 \\ {r}_{a 2} \\ {r}_{a 3} \\ {r}_{a 4}\end{matrix} ) \qquad ( Eq . 4 )$$

where rₐ₁, rₐ₂, rₐ₃, and rₐ₄ are the signal strengths of the signal transmitted from the STA 3a as received by the antennas 41-1, 41-2, 41-3, and 41-4 at the AP 2, respectively. In the above equation, the signal strength rₐ₁ of the signal as received by the antenna 41-1 is set to 0. (Practically, the signal strength rₐ₁ may be set lower than a predetermined level.) Since the signal strengths rₐ₂, rₐ₃, and rₐ₄ at the other antennas are arbitrary, it is only necessary to satisfy Eq. 5 below.

hₐ₁₁(Wₐ₁₁tₐ₁+Wₐ₁₂tₐ₂)+hₐ₁₂(wₐ₂₁tₐ₂+wₐ₂₂tₐ₂)=0 (Eq. 5)

Since Eq. 5 must hold for any value of Tₐ (i.e., any value of tₐ₁ and any value of tₐ₂), the following equations are derived.

$$\{ \begin{matrix}{h}_{a 11} {w}_{a 11} + {h}_{a 12} {w}_{a 21} = 0 \\ {h}_{a 11} {w}_{a 12} + {h}_{a 12} {w}_{a 22} = 0\end{matrix} \qquad ( Eq . 6 )$$

Solving these equations gives the weight vector Wₐ, as represented by the following equations. The STA 3a applies this weight vector to its transmission signal to ensure that the multipath copies of the signal cancel each other at the antenna 41-1 at the AP 2.

$$\{ \begin{matrix}{w}_{a 11} = - \frac{{h}_{a 12}}{{h}_{a 11}} {w}_{a 21} \\ {w}_{a 12} = - \frac{{h}_{a 12}}{{h}_{a 11}} {w}_{a 22}\end{matrix} \qquad ( Eq . 7 )$$

Likewise, the weight vector W_{b} is determined such that the STA 3b steers a null in the radiation pattern toward the antenna 41-2 at the AP 2. The following equations represent the determined weight vector W_{b}.

$$\{ \begin{matrix}{w}_{b 11} = - \frac{{h}_{b 12}}{{h}_{b 11}} {w}_{b 21} \\ {w}_{b 12} = - \frac{{h}_{b 12}}{{h}_{b 11}} {w}_{b 22}\end{matrix} \qquad ( Eq . 8 )$$

The STA 3b applies this weight vector to its transmission signal to ensure that the multipath copies of the signal cancel each other at the antenna 41-2 of the AP 2.

The MIMO wireless communication system of the present embodiment has been described such that the APs and the STAs have four and two antennas, respectively, and each AP communicates with only two STAs at one time. However, the APs and the STAs may have a different number of antennas and each AP may communicate with a different number of STAs at one time while ensuring that each STA can steer a null in the radiation pattern toward an antenna at the AP. Specifically, the number of STAs with which an AP communicates at one time and the number of antennas at the AP must satisfy Eq. 9 below. Further, the smallest number of antennas at these STAs must satisfy Eq. 10 below.

A^{(AP)}≦T (Eq. 9)

Minᵢ(Aᵢ^{(STA)})≧T (Eq. 10)

where: A^{(AP)} is the number of antennas at the AP; T is the number of STAs with which the AP communicates at one time; and Minᵢ (Aᵢ^{(STA)}) is the smallest number of antennas used at these STAs. (These equations are based on an elementary linear algebra theory.)

With the system configured in this way, a plurality of STAs can simultaneously transmit their respective ACK packets to an AP such that each packet is received by a different one of the plurality of antennas at the AP. This allows the AP to properly receive the ACK packets from these STAs without performing MIMO processing. This means that the signals transmitted from the STAs can be demodulated even if they differ in carrier frequency and transmission timing.

In the present embodiment, each STA that desires to communicate with an AP notifies the AP of the number of antennas at the STA before actual data transmission. However, such notification may be omitted when only certain predetermined STAs and APs communicate with each other, or when the number of antennas at each STA is already known (for example, when the STAs are of the same type).

Thus, according to the present embodiment, a second MIMO wireless communication apparatus (or access point) can properly receive and demodulate signals simultaneously transmitted from a plurality of first MIMO wireless communication apparatuses (or user terminals or stations) even if these signals differ in carrier frequency and transmission timing.

Further according to the present embodiment, each first MIMO wireless communication apparatus notifies the second MIMO wireless communication apparatus of the number of antennas at the first MIMO wireless communication apparatus before actual data transmission. This permits the MIMO wireless communication system to function properly even if one or more of the first MIMO wireless communication apparatuses have only one antenna.

Further, the present embodiment can eliminate the need for a special step in which each first MIMO wireless communication apparatus notifies the second MIMO wireless communication apparatus of the number of antennas at the first MIMO wireless communication apparatus before actual data transmission.

Further, the first and second MIMO wireless communication apparatuses can estimate the uplink and downlink channels (and generate uplink and downlink channel state information), respectively, from received signals, thereby eliminating the need for a separate channel state information transmission/reception process.

Still further, the present embodiment allows the second MIMO wireless communication apparatus to properly receive and demodulate signals simultaneously transmitted from a plurality of first MIMO wireless communication apparatuses even if these signals differ in carrier frequency and transmission timing.

### Second Embodiment

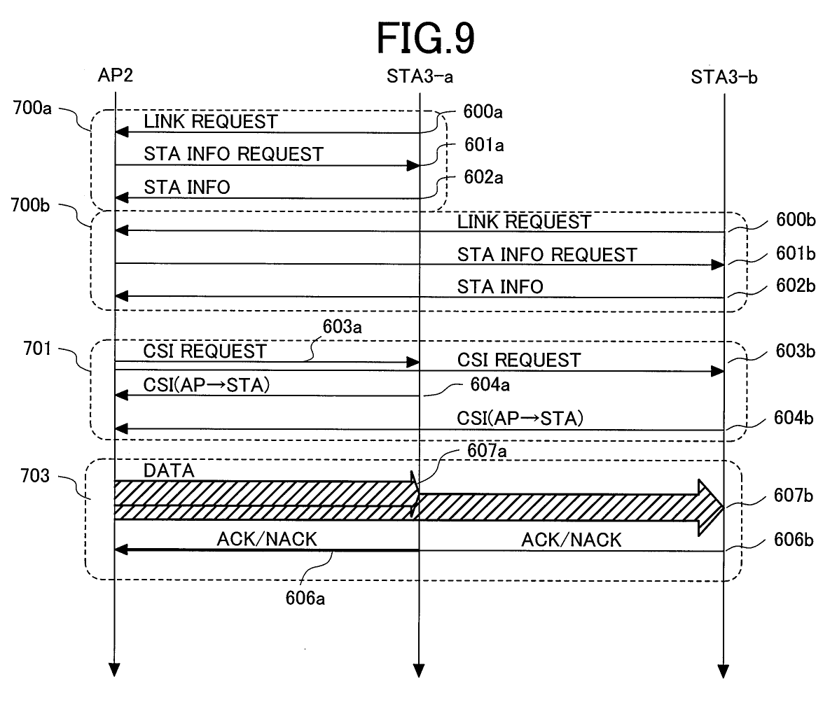

A second embodiment of the present invention will now be described with reference to FIGS. 5 and 9.

FIG. 9 is a timing chart of a communication procedure between an access point (AP 2) and stations (STAs 3) according to the second embodiment, showing steps from the acquisition of channel state information to the transmission of data packets.

According to the present embodiment, after the AP 2 has simultaneously transmitted data packets to a plurality of STAs 3, each of these STAs 3 generates an ACK packet, performs signal processing on the ACK packet based on channel state information obtained from the data packet received from the AP 2, and then transmits the processed ACK packet to the AP 2.

Specifically, referring to FIG. 9, the AP 2 first performs first and second steps 700 and 701 which are similar to those described above in connection with the first embodiment. However, when receiving channel state information packets 604a and 604b from the STAs 3-a and 3-b at step 701, the AP 2 does not generate uplink (i.e., STA-to-AP) channel state information although it demodulates the signals. Then at a third step 703, the AP 2 transmits data packets 607a and 607b to the STAs 3-a and 3-b, respectively. It should be noted that, unlike in the first embodiment, these data packets do not contain uplink channel state information. The STAs 3-a and 3-b then transmit response packets 606a and 606b, respectively, to the AP 2 based on their respective downlink (i.e., AP-to-STA) channel state information which was obtained by their MIMO receive processing unit 213 at the time of the reception of the data packets 607a and 607b from the AP 2. That is, the present embodiment assumes that the uplink and downlink channel states are substantially identical.

With the system configured in this way, a plurality of STAs can simultaneously transmit their respective ACK packets to an AP such that each packet is received by a different one of the plurality of antennas at the AP. This allows the AP to properly demodulate the ACK packets from these STAs without performing MIMO processing, as in the first embodiment.

Further, according to the present embodiment, each STA 3 transmits data to the AP 2 based on downlink (not uplink) channel state information that the STA 3 generated at the time of the reception of data from the AP 2, by assuming that the uplink and downlink channel states are substantially identical. This eliminates the need for the AP 2 to include uplink channel state information into the data transmitted to each STA 3, which allows reduction of the packet length resulting in increased throughput.

What is claimed is:

1. A MIMO wireless communication system comprising:
at least one first MIMO (Multiple Input Multiple Output) wireless communication apparatus having a plurality of antennas for transmitting a signal; and
a second MIMO wireless communication apparatus having a plurality of antennas for receiving said signal transmitted from said at least one first MIMO wireless communication apparatus;
wherein said at least one first MIMO wireless communication apparatus controls said signal transmitted from its said plurality of antennas based on channel state information for a communication channel between said at least one first MIMO wireless communication apparatus and said second MIMO wireless communication apparatus such that the signal strength of said signal as received by at least one of said plurality of antennas of said second MIMO wireless communication apparatus does not exceed zero or a predetermined level.

2. A MIMO wireless communication system as claimed in claim 1, wherein it is arranged that at least one of said plurality of antennas of said second MIMO wireless communication apparatus only receives signals transmitted from one of said at least one first MIMO wireless communication apparatus.

3. A MIMO wireless communication system as claimed in claim 1, wherein:
one or more of said at least one first MIMO wireless communication apparatus simultaneously transmit signals to said second MIMO wireless communication apparatus; and
the number of said one or more first MIMO wireless communication apparatuses is smaller than the number of said plurality of antennas of said second MIMO wireless communication apparatus and also smaller than the smallest number of antennas of any of said at least one first MIMO wireless communication apparatus.

4. A MIMO wireless communication system as claimed in claim 1, wherein said at least one first MIMO wireless communication apparatus generates channel state information by channel estimation based on a signal transmitted from said second MIMO wireless communication apparatus.

5. A MIMO wireless communication system as claimed in claim 4, wherein:
said second MIMO wireless communication apparatus transmits data packets to a plurality of said at least one first MIMO wireless communication apparatus;
each of said plurality of said at least one first MIMO wireless communication apparatus generates channel state information by channel estimation based on a data packet received from said second MIMO wireless communication apparatus, and transmits a response packet to said second MIMO wireless communication apparatus based on said channel state information, said response packet indicating whether or not data contained in said data packet is erroneous.

6. A MIMO wireless communication system as claimed in claim 1, wherein:
said second MIMO wireless communication apparatus generates channel state information by channel estimation based on said signal transmitted from said at least one first MIMO wireless communication apparatus, and transmits a signal containing said channel state information to said at least one first MIMO wireless communication apparatus; and
said at least one first MIMO wireless communication apparatus demodulates said signal transmitted from said second MIMO wireless communication apparatus and obtains said channel state information contained in said signal.

7. A MIMO wireless communication system as claimed in claim 6, wherein:
said second MIMO wireless communication apparatus transmits a packet transmission request to each of a plurality of said at least one first MIMO wireless communication apparatus;
said each of said plurality of said at least one first MIMO wireless communication apparatus transmits a packet to said second MIMO wireless communication apparatus in response to said packet transmission request;
said second MIMO wireless communication apparatus generates channel state information by channel estimation based on said packet transmitted from said each of said plurality of said at least one first MIMO wireless communication apparatus, and transmits a data packet containing said channel state information to said each of said plurality of said at least one first MIMO wireless communication apparatus; and
said each of said plurality of said at least one first MIMO wireless communication apparatus obtains data and said channel state information from said data packet transmitted from said second MIMO wireless communication apparatus, and transmits a response packet to said second MIMO wireless communication apparatus based on said channel state information, said response packet indicating whether or not said data is erroneous.

8. A MIMO wireless communication system as claimed in claim 1, wherein in response to an inquiry from said second MIMO wireless communication apparatus, said at least one first MIMO wireless communication apparatus notifies said second MIMO wireless communication apparatus of the number of antennas of said at least one first MIMO wireless communication apparatus.

9. A MIMO wireless communication system as claimed in claim 1, wherein said second MIMO wireless communication apparatus begins data communication with said at least one first MIMO wireless communication apparatus after obtaining information about the number of antennas of said at least one first MIMO wireless communication apparatus.

10. A MIMO wireless communication system as claimed in claim 1, wherein:
said second MIMO wireless communication apparatus communicates with one or more of said at least one first MIMO wireless communication apparatus; and
said second MIMO wireless communication apparatus obtains information about the number of said one or more first MIMO wireless communication apparatuses and information about the number of antennas of each of said at least one first MIMO wireless communication apparatus before beginning any communication with said at least one first MIMO wireless communication apparatus.

11. A MIMO wireless communication apparatus for transmitting a signal to another MIMO wireless communication apparatus by using a plurality of antennas, said MIMO wireless communication apparatus comprising:
a channel state information storage unit for storing channel state information for a communication channel between said MIMO wireless communication apparatus and said another MIMO wireless communication apparatus; and
a transmission signal controller for controlling said signal based on channel state information stored in said channel state information storage unit such that the signal strength of said signal as received by at least one of a plurality of antennas of said another MIMO wireless communication apparatus does not exceed zero or a predetermined level.

12. A MIMO wireless communication apparatus as claimed in claim 11, further comprising:
a channel estimation unit for generating channel state information by channel estimation based on a signal transmitted from said another MIMO wireless communication apparatus.

13. A MIMO wireless communication apparatus as claimed in claim 12, wherein said signal transmitted from said another MIMO wireless communication apparatus is a data packet.

14. A MIMO wireless communication apparatus as claimed in claim 11, further comprising:
a MAC processing unit for demodulating a signal transmitted from said another MIMO wireless communication apparatus and retrieving channel state information contained in said signal.

15. A MIMO wireless communication apparatus as claimed in claim 14, wherein said signal transmitted from said another MIMO wireless communication apparatus is a data packet.

16. A wireless communication method for a MIMO wireless communication system, wherein said MIMO wireless communication system includes at least one first MIMO wireless communication apparatus and a second MIMO wireless communication apparatus, wherein said at least one first MIMO wireless communication apparatus has a plurality of antennas for transmitting a signal, and wherein said second MIMO wireless communication apparatus has a plurality of antennas for receiving said signal transmitted from said at least one first MIMO wireless communication apparatus, said wireless communication method comprising:
a channel state information generating step of said at least one first MIMO wireless communication apparatus generating channel state information for a communication channel between said at least one first MIMO wireless communication apparatus and said second MIMO wireless communication apparatus by channel estimation based on a signal transmitted from said second MIMO wireless communication apparatus;
a transmission signal control step of said at least one first MIMO wireless communication apparatus controlling said signal transmitted from its said plurality of antennas based on said channel state information such that the signal strength of said signal as received by at least one of said plurality of antennas of said second MIMO wireless communication apparatus does not exceed zero or a predetermined level; and
a signal receiving step of, without performing signal-demultiplexing by MIMO processing, said second MIMO wireless communication apparatus receiving said signal transmitted from said at least one first MIMO wireless communication apparatus by using at least one of said plurality of antennas of said second MIMO wireless communication apparatus.

17. A wireless communication method as claimed in claim 16, wherein said channel state information generating step includes the steps of:
said second MIMO wireless communication apparatus transmitting data packets to a plurality of said at least one first MIMO wireless communication apparatus; and
each of said plurality of said at least one first MIMO wireless communication apparatus generating channel state information by channel estimation based on a data packet received from said second MIMO wireless communication apparatus, and transmitting a response packet to said second MIMO wireless communication apparatus based on said channel state information, said response packet indicating whether or not data contained in said data packet is erroneous.

18. A wireless communication method as claimed in claim 16, wherein:
one or more of said at least one first MIMO wireless communication apparatus simultaneously transmit signals to said second MIMO wireless communication apparatus; and
the number of said one or more first MIMO wireless communication apparatuses is smaller than the number of said plurality of antennas of said second MIMO wireless communication apparatus and also smaller than the smallest number of antennas of any of said at least one first MIMO wireless communication apparatus.

19. A wireless communication method as claimed in claim 16, further comprising the step of:
said at least one first MIMO wireless communication apparatus notifying said second MIMO wireless communication apparatus of the number of antennas of said at least one first MIMO wireless communication apparatus in response to an inquiry from said second MIMO wireless communication apparatus.

20. A wireless communication method as claimed in claim 16, further comprising the step of:
said second MIMO wireless communication apparatus beginning data communication with said at least one first MIMO wireless communication apparatus after obtaining information about the number of antennas of said at least one first MIMO wireless communication apparatus.
